(19) United States
(12) Patent Application Publication
(10) Pub. No.: US 2009/0278515 A1
(43) Pub. Date: Nov. 12, 2009

(54) MULTIPLE OUTPUT VOLTAGE REGULATOR

(76) Inventors: RODNEY BROUSSARD, Soperton, GA (US); James D. Strom, Rochester, MN (US)

Correspondence Address: IBM CORPORATION, 3605 HIGHWAY 52 NORTH, DEPT 917, ROCHESTER, MN, 55901-7829, US

(21) Appl. No.: 12/116,742

(22) Filed: May 7, 2008

(51) Int. Cl. G05F 1/577; G05F 1/44

(52) U.S. Cl. 323/267; 323/265

(57) ABSTRACT

A multiple output voltage regulator includes a voltage regulator amplifier, a first device, and a second device. The voltage regulator amplifier includes a first input configured to receive a reference voltage and an output. The first device includes a first terminal, a second terminal, and a control terminal. The control terminal of the first device is coupled to the output of the voltage regulator amplifier, the first terminal of the first device is coupled to a power supply terminal, and the second terminal of the first device is coupled to a second input of the voltage regulator amplifier (to provide negative feedback) and is configured to be coupled to one side of a first load. The second device includes a first terminal, a second terminal, and a control terminal. The control terminal of the second device is coupled to the output of the voltage regulator amplifier, the first terminal of the second device is coupled to a power supply terminal, and the second terminal of the second device is configured to be coupled to one side of a second load.

### BACKGROUND

1. Field

This disclosure relates generally to a voltage regulator and, more specifically, to a multiple output voltage regulator.

2. Related Art

Today, phase-locked loops (PLLs) are widely used in radios, telecommunication equipment, computer systems, and other electronic applications. PLLs may be used, for example, to generate stable frequencies, recover a signal from a noisy communication channel, or distribute clock timing pulses in digital logic designs (such a processors). In general, a PLL functions as a negative feedback control system that generates an output signal that has a fixed relation to a phase and frequency of an input signal.

As a logic area of integrated circuit (IC) designs that include PLLs has decreased, a PLL macro area has generally become a greater percentage of a total IC area, as the PLL macro area has not usually scaled with the logic area. In general, the PLL macro area has not scaled due to the utilization of thick-oxide decoupling capacitors and the utilization of long-channel and thick-oxide metal-oxide semiconductor field-effect transistors (MOSFETs) employed in traditional PLL designs. Conventional PLL macros have usually employed two voltage regulators (i.e., a first voltage regulator for analog circuitry (such as a charge pump (CP) and a voltage controlled oscillator (VCO)) and a second voltage regulator for digital circuitry (such as a feedback divider, a VCO divider, and other miscellaneous logic (e.g., a phase/frequency detector and multiplexers)). That is, digital circuitry has employed a different voltage regulator than noise sensitive analog circuitry to isolate the digital circuitry and the analog circuitry. In a typical PLL macro that employs two voltage regulators (e.g., a first voltage regulator for analog circuitry and a second voltage regulator for digital circuitry), the two voltage regulators have usually consumed about forty to fifty percent of a total PLL area.

With reference to FIG. 1, a relevant portion of a conventional voltage regulator 100, that provides analog and digital voltages (VDD2 and VDD1, respectively) to a PLL (represented by analog load 106 and digital load 108) using two different voltage regulators, is illustrated. The regulator 100 may, for example, employ a silicon-on-insulator (SOI) technology. As is shown, a voltage regulator amplifier RA1 provides power to the analog load 106, via an n-channel metal-oxide semiconductor field-effect transistor (MOSFET) 102, responsive to a reference voltage (VREF). Similarly, a voltage regulator amplifier RA2 provides power to the digital load 108, via a MOSFET 104, responsive to the reference voltage (VREF). As is also illustrated, a decoupling capacitor C1 (e.g., a 68 picofarad capacitor) and a decoupling capacitor C2 (e.g., another 68 picofarad capacitor) are implemented to filter VDD2 and VDD1, respectively. As noted above, in a typical PLL macro that employs two voltage regulators (such as the regulators RA1 and RA2), the two voltage regulators have usually consumed about forty to fifty percent of a total PLL area.

### SUMMARY

According to one aspect of the present disclosure, a multiple output voltage regulator includes a voltage regulator amplifier, a first device, and a second device. The voltage regulator amplifier includes a first input configured to receive a reference voltage and an output. The first device includes a first terminal, a second terminal, and a control terminal. The control terminal of the first device is coupled to the output of the voltage regulator amplifier, the first terminal of the first device is coupled to a power supply terminal, and the second terminal of the first device is coupled to a second input of the voltage regulator amplifier (to provide negative feedback) and is configured to be coupled to one side of a first load. The second device includes a first terminal, a second terminal, and a control terminal. The control terminal of the second device is coupled to the output of the voltage regulator amplifier, the first terminal of the second device is coupled to the power supply terminal, and the second terminal of the second device is configured to be coupled to one side of a second load.

According to another aspect of the present disclosure, an integrated circuit includes a phase-locked loop (that is divided into a first load and a second load) and a multiple output voltage regulator. The multiple output voltage regulator includes a voltage regulator amplifier, a first device, and a second device. The voltage regulator amplifier includes a first input configured to receive a reference voltage and an output. The first device includes a first terminal, a second terminal, and a control terminal. The control terminal of the first device is coupled to the output of the voltage regulator amplifier, the first terminal is coupled to a power supply terminal, and the second terminal is coupled to a second input of the voltage regulator amplifier (to provide negative feedback) and to one side of the first load. The second device includes a first terminal, a second terminal, and a control terminal. The control terminal of the second device is coupled to the output of the voltage regulator amplifier, the first terminal is coupled to a power supply terminal, and the second terminal is coupled to one side of the second load.

### BRIEF DESCRIPTION OF THE DRAWINGS

The present invention is illustrated by way of example and is not intended to be limited by the accompanying figures, in which like references indicate similar elements. Elements in the figures are illustrated for simplicity and clarity and have not necessarily been drawn to scale.

FIG. 1 is a diagram of a relevant portion of an example conventional voltage regulator for a phase-locked loop (PLL) that includes two voltage regulator amplifiers for separately powering analog and digital circuitry of the PLL.

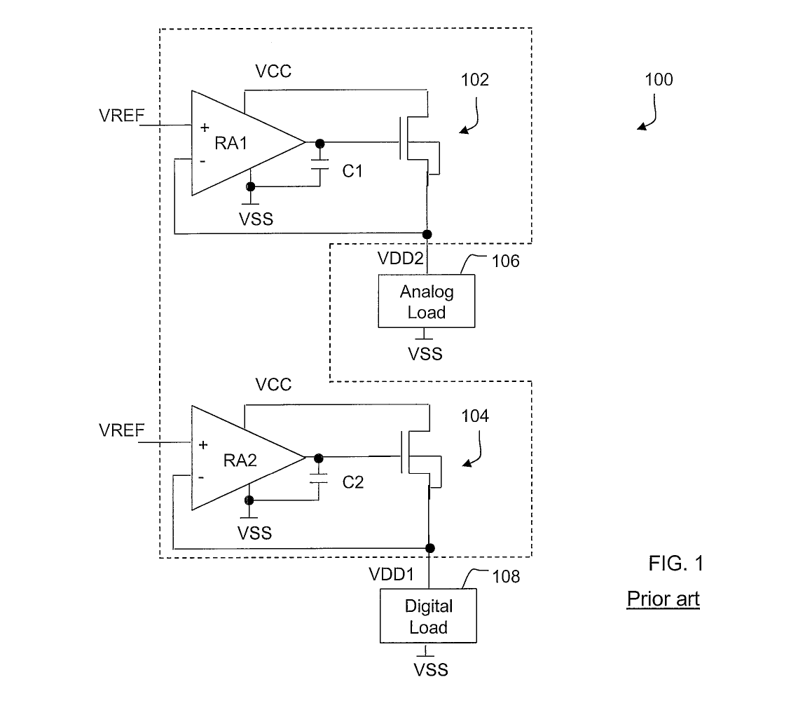

FIG. 2 is a diagram of a relevant portion of an example voltage regulator for a PLL that powers both analog and digital circuitry of the PLL with a single voltage regulator amplifier (while providing a desired isolation between the analog and digital circuitry), according to the present disclosure.

FIG. 3 is a diagram of a PLL that is powered by the voltage regulator of FIG. 2.

FIG. 4 is a block diagram of an example computer system that may be configured to include one or more voltage regulators configured according to FIG. 2.

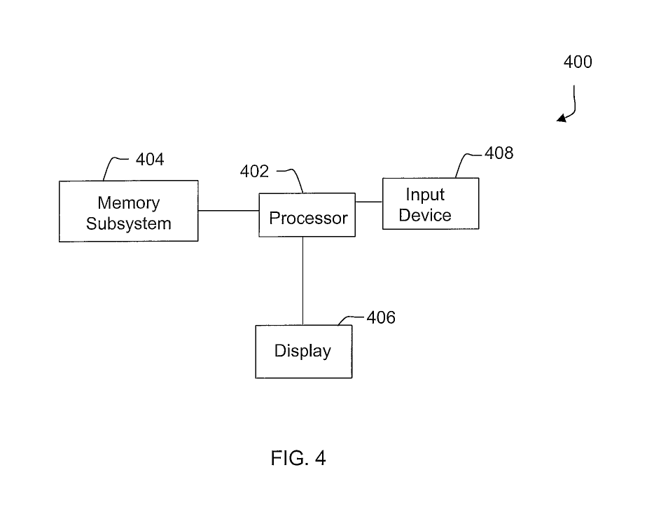

### DETAILED DESCRIPTION

As will be appreciated by one of ordinary skill in the art, the present invention may be embodied as a method, system, device, or computer program product. Accordingly, the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” For example, the present invention may take the form of one or more design files included in a computer program product on a computer-usable storage medium having computer-usable program code embodied in the medium.

Any suitable computer-usable or computer-readable storage medium may be utilized. The computer-usable or computer-readable storage medium may be, for example, but is not limited to an electronic, magnetic, optical, electromagnetic, infrared, or semiconductor system, apparatus, or device. More specific examples (a non-exhaustive list) of the computer-readable medium includes the following: a portable computer diskette, a hard disk, a random access memory (RAM), a read-only memory (ROM), an erasable programmable read-only memory (EPROM) or flash memory, a portable compact disc read-only memory (CD-ROM), an optical storage device, or a magnetic storage device. Note that the computer-usable or computer-readable storage medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this disclosure, a computer-usable or computer-readable storage medium may be any medium that can contain or store a program for use by or in connection with an instruction execution system, apparatus, or device. As used herein, the term “coupled” includes both a direct electrical connection between blocks or components and an indirect electrical connection between blocks or components achieved using one or more intervening blocks or components.

According to various aspects of the present disclosure, an area of a phase-locked loop (PLL) macro may be reduced by replacing two voltage regulators with a single voltage regulator in combination with a source follower. In a disclosed embodiment, a single voltage regulator is configured as a closed-loop regulator to provide a first power source to an analog load and a source follower is implemented in combination with the single voltage regulator to provide a second power source to a digital load. Alternatively, the digital load may be swapped with the analog load or both of the loads may be digital loads or analog loads. In various configurations, the source follower (which taps off a compensation node of the single voltage regulator) has nearly the same power supply rejection (PSR) as the single voltage regulator. However, employing the source follower in combination with the single voltage regulator advantageously reduces an area required for voltage regulation by about fifty-four percent. The source follower may be scaled to provide a minimum voltage (VMIN) of an appropriate value to ensure proper functionality of circuits in an associated load.

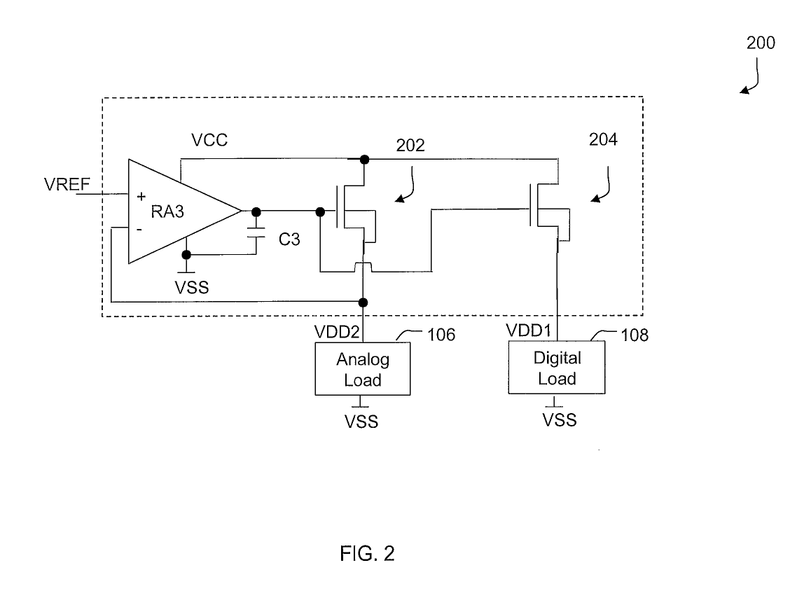

With reference to FIG. 2, a relevant portion of a voltage regulator 200, that provides analog and digital voltages (VDD2 and VDD1, respectively) to a PLL (represented by analog load 106 and digital load 108) using a single voltage regulator in combination with a source follower, is illustrated. As is shown, a voltage regulator amplifier RA3 provides power to the analog load 106, via an n-channel MOSFET 202, responsive to a reference voltage (VREF). In this case, an n-channel MOSFET 204 (which is configured as a source follower) provides power to the digital load 108, responsive to the reference voltage (VREF). The regulator 200 may, for example, employ a silicon-on-insulator (SOI) technology. As noted above, employing a source follower in combination with a single regulator advantageously reduces an area required for PLL voltage regulation by about fifty-four percent.

The reduction in area is mainly attributable to the implementation of a single decoupling capacitor C3 in the regulator 200 (as opposed to two decoupling capacitors C1 and C2 in the regulator 100) and the fact that only one voltage regulator amplifier RA3 is employed (as opposed to the two voltage regulators amplifiers RA1 and RA2 in the regulator 100). The capacitor C3 may, for example, be a sixty-seven picofarad capacitor. The MOSFET 204 may be scaled such that a current density of the MOSFET 204 matches the current density of the MOSFET 202. It should be appreciated that the voltages VDD2 and VDD1 may be substantially the same level or the voltage VDD1 may be slightly lower than the voltage VDD2 (limited by a threshold of the devices). For example, a width of the MOSFET 202 may be set at 2900 microns and a width of the MOSFET 204 may be a multiple of 2800 microns.

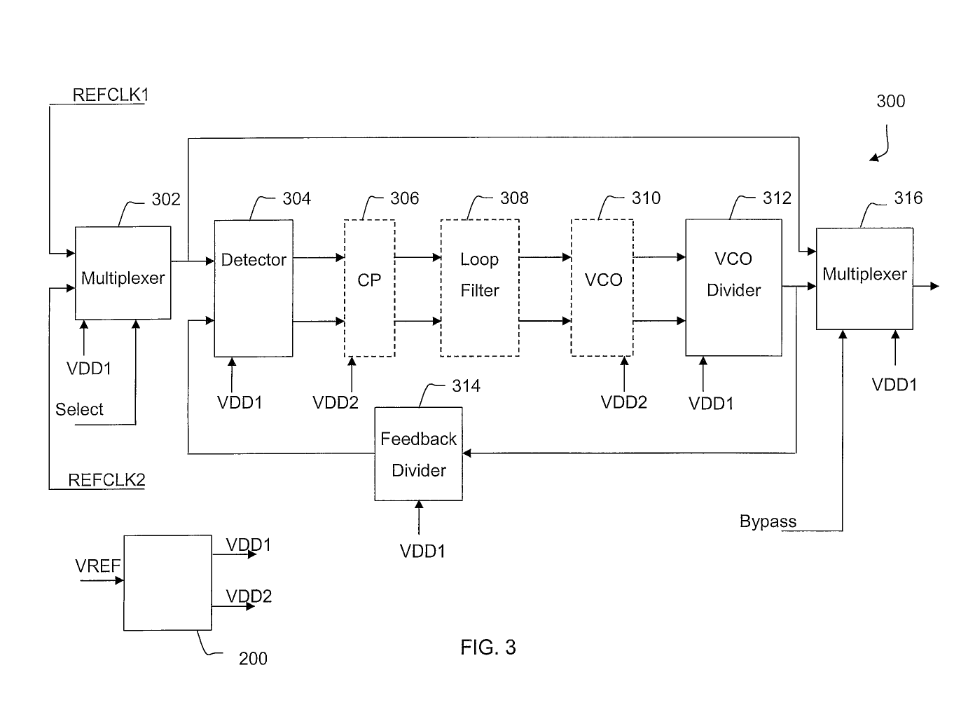

With reference to FIG. 3, an example PLL 300 is depicted. As is shown the PLL 300 includes an input multiplexer 302 and an output multiplexer 316. The input multiplexer 302 facilitates selection between multiple reference signals (REFCLK1 and REFCLK2) and the output multiplexer 316 facilitates bypassing the PLL 300 and providing a reference signal directly to an output of the PLL 300. A selected reference signal is coupled (by the multiplexer 302) to a first input of phase/frequency detector 304. Outputs of the detector 304 are coupled to inputs of charge pump (CP) 306. Outputs of the CP 306 are coupled to inputs of loop filter 308 and outputs of the loop filter 308 are coupled to inputs of VCO 310, whose outputs are coupled to inputs of VCO divider 312. An output of the VCO divider 312 is coupled to an input of the multiplexer 316 and an input of feedback divider 314, whose output is coupled to a second input of the detector 304. As is shown, the voltage regulator 200 provides a first voltage VDD1 to the multiplexers 302 and 316, the detector 304, the VCO divider 312, and the feedback divider 314. The voltage regulator 200 also provides a second voltage VDD2 to the CP 306 and the VCO 310.

With reference to FIG. 5, an example computer system 500 is illustrated that may include one or voltage regulators configured according to various embodiments of the present disclosure. The computer system 500 includes a processor 502 that is coupled to a memory subsystem 504, a display 506, and an input device 508. The processor 502 may, for example, include one or more PLLs that each include a voltage regulator configured according to the present disclosure. The memory subsystem 504 includes an application appropriate amount of volatile memory (e.g., dynamic random access memory (DRAM)) and non-volatile memory (e.g., read-only memory (ROM) or flash memory). The display 506 may be, for example, a cathode ray tube (CRT) or a liquid crystal display (LCD). The input device 508 may include, for example, a pointing device such as a mouse and a keyboard. The processor 502 may also be coupled to one or more mass storage devices, e.g., a compact disc read-only memory (CD-ROM) drive and/or a hard disk drive (HDD).

Accordingly, techniques have been disclosed herein that reduce an area required for implementing a PLL macro within an integrated circuit. While the disclosed example is directed to a multiple output voltage regulator for a PLL, it is contemplated that the techniques disclosed herein are broadly applicable to other macros that require multiple voltage regulators for isolation. Moreover, it is contemplated that the techniques disclosed herein may be employed using different device types (e.g., p-channel MOSFETs) and device families, other than those disclosed herein.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A multiple output voltage regulator, comprising:
a voltage regulator amplifier including a first input configured to receive a reference voltage and an output;
a first device including a first terminal, a second terminal, and a control terminal, wherein the control terminal of the first device is coupled to the output of the voltage regulator amplifier, the first terminal of the first device is coupled to a power supply terminal, and the second terminal of the first device is coupled to a second input of the voltage regulator amplifier and is configured to be coupled to one side of a first load; and
a second device including a first terminal, a second terminal, and a control terminal, wherein the control terminal of the second device is coupled to the output of the voltage regulator amplifier, the first terminal of the second device is coupled to the power supply terminal, and the second terminal of the second is configured to be coupled to one side of a second load.

2. The multiple output voltage regulator of claim 1, where the first and second devices are n-channel metal-oxide semiconductor field-effect transistors.

3. The multiple output voltage regulator of claim 1, where the first load is an analog load and the second load is a digital load.

4. The multiple output voltage regulator of claim 1, wherein the second device is a scaled version of the first device, and wherein a current density of the first and second devices is substantially equal.

5. The multiple output voltage regulator of claim 1, wherein the multiple output voltage regulator is formed using a silicon-on-insulator technology.

6. An integrated circuit, comprising:
a phase-locked loop divided into a first load and a second load; and
a multiple output voltage regulator, comprising:
a voltage regulator amplifier including a first input configured to receive a reference voltage and an output;
a first device including a first terminal, a second terminal, and a control terminal, wherein the control terminal of the first device is coupled to the output of the voltage regulator amplifier, the first terminal is coupled to a power supply terminal, and the second terminal is coupled to a second input of the voltage regulator amplifier and one side of the first load; and
a second device including a first terminal, a second terminal, and a control terminal, wherein the control terminal of the second device is coupled to the output of the voltage regulator amplifier, the first terminal is coupled to a power supply terminal, and the second terminal is coupled to one side of the second load.

7. The integrated circuit of claim 6, where the first and second devices are n-channel metal-oxide semiconductor field-effect transistors.

8. The integrated circuit of claim 6, where the first load is an analog load and the second load is a digital load.

9. The integrated circuit of claim 6, wherein the second device is a scaled version of the first device, and wherein a current density of the first and second devices is substantially equal.

10. The integrated circuit of claim 6, wherein the integrated circuit is formed using a silicon-on-insulator technology.
